(19) United States
(12) Patent Application Publication
(10) Pub. No.: US 2021/0222307 A1
(43) Pub. Date: Jul. 22, 2021

(54) METHOD OF MAINTAINING AN ELECTROLYSIS CELL AT OPERATIONAL TEMPERATURE AND AN ELECTROLYSIS CELL

(71) Applicant: Empire Hydrogen Energy Systems Inc., Sidney (CA)

(72) Inventor: Andrew EVANS, Victoria (CA)

(21) Appl. No.: 17/145,604

(22) Filed: Jan. 11, 2021

(30) Foreign Application Priority Data
Jan. 17, 2020 (CA) 3068488

(51) Int. Cl. C25B 9/67; C25B 1/04

(52) U.S. Cl. CPC C25B 9/67; C25B 1/04

(57) ABSTRACT

A method of maintaining an electrolysis cell at operational temperature. The method involves incorporating a heating manifold into a cell body of the electrolysis cell, the heating manifold having at least one heating element and positioning at least one temperature sensor in communication with the cell body. The method then involves monitoring temperature readings received from the at least one temperature sensor and turning the at least one heating element on and off to maintain the cell body within a predetermined temperature range.

Method of maintaining an electrolysis cell at operational temperature and an Electrolysis cell modified in accordance with the method

### FIELD

There is describe a method of maintaining an electrolysis cell at operational temperature and an electrolysis cell modified in accordance with the method

### BACKGROUND

Cells for the purpose of electrolysing water and generating hydrogen and oxygen gases are occasionally used to introduce these gases into combustion chambers of engines for the purpose of increasing the engine fuel efficiency and reducing harmful emissions.

These combustion engines may either be stationary or mobile transport applications, and in both cases there are thermal operational and storage constraints that must be observed to avoid damage and operate in an efficient manner. Often for these stationary engines, and always for the mobile engines, they are subject to environments where ambient temperature can vary from far below zero to above 40° C. When an electrolytic cell is working it generates heat, but is subject to damaging cold when idle or stored, so additional heat is desired to avoid freeze damage in sub-zero conditions.

The optimal operational temperature for electrolysing cells is approximately 20° C.-45° C. so it is desirable to quickly move into this range and avoid operation outside of this range.

### SUMMARY

According to one aspect, there is provided a method of maintaining an electrolysis cell at operational temperature. A step of the method involves incorporating a heating manifold into a cell body of the electrolysis cell, the heating manifold having at least one heating element. A step involves positioning at least one temperature sensor in communication with the cell body. A step involves monitoring temperature readings received from the at least one temperature sensor and turning the at least one heating element on and off to maintain the cell body within a predetermined temperature range.

According to another aspect there is provided an electrolysis cell constructed in accordance with the teachings of the method. The electrolysis cell having a cell body with a heating manifold incorporated into the cell body. At least one heating element is supported by the heating manifold. At least one temperature sensor is in communication with the cell body. A controller monitors temperature readings received from the at least one temperature sensor and turns the at least one heating element on and off to maintain the cell body within a predetermined temperature range.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an electrolysis cell.

FIG. 2 is a perspective view of a heating manifold from the electrolysis cell of FIG. 1

FIG. 3 is a side elevation view of the heating manifold from the electrolysis cell of FIG. 1.

### DETAILED DESCRIPTION

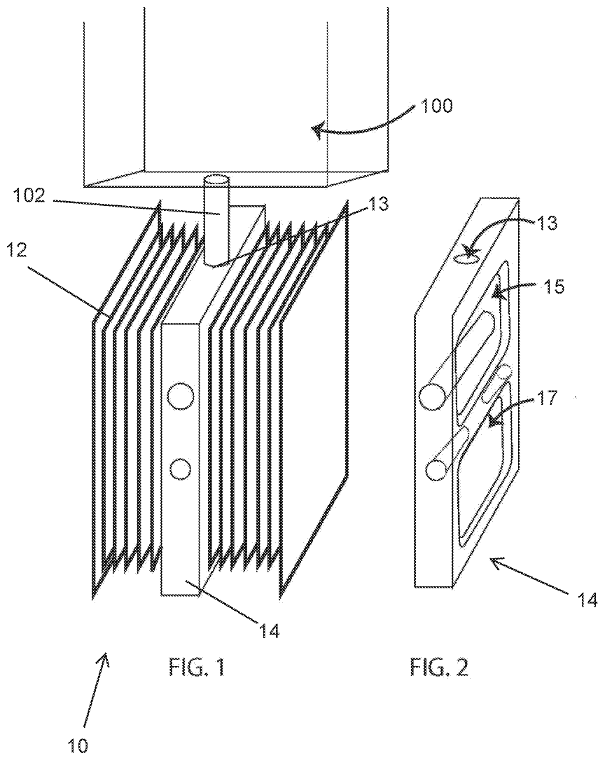

An electrolysis cell, generally identified by reference numeral 10, and its method of operation will now be described with reference to FIG. 1 through FIG. 3.

Structure and Relationship of Parts:

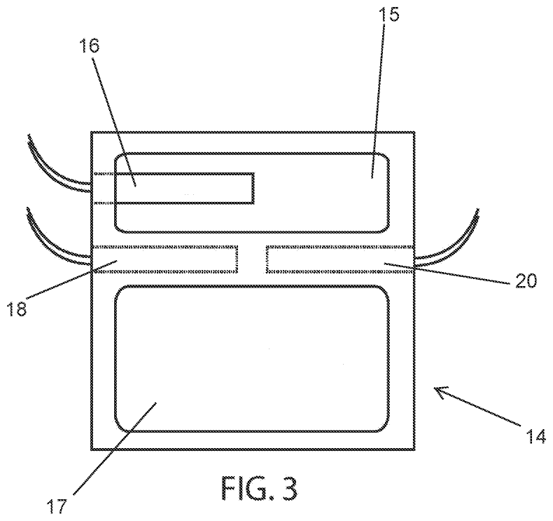

Referring to FIG. 1, electrolysis cell 10 has a cell body 12 with a heating manifold 14 incorporated into cell body 12. Heating manifold 14 is centrally positioned and divides cell body into two halves. Referring to FIG. 3, heating manifold 14 has a top cavity 15 and a bottom cavity 17, so that fluid can pass freely between the two halves of cell body 12. Referring to FIG. 3, a heating element, in the form of heating pin 16 is supported by heating manifold 14. There are two temperature sensors 18 and 20 in communication with cell body 12. A controller (not shown) monitors temperature readings received from temperature sensors 18 and 20 and turns heating pin 16 on and off to maintain cell body 12 within a predetermined temperature range.

Referring to FIG. 3, heating manifold 14 within electrolysis cell 10 provides a mechanical mounting for heating pin 16 and temperature sensors 18 and 20.

Referring to FIG. 1, there is a connection of electrolysis cell 10 to a fluid reservoir 100 positioned directly above the heating manifold 14, allowing for the convection circulation of heated fluid from electrolysis cell 10 to reservoir 100 via connecting conduit 102 which connects to an entry port 13 into heating manifold 14.

### Operation

In accordance with the method of maintaining an electrolysis cell at operational temperature. Referring to FIG. 1 the method involves incorporating heating manifold 14 into cell body 12 of electrolysis cell 10. Referring to FIG. 3, heating manifold has having at least one heating element, shown in the form of heating pin 16. The method involves positioning at least one temperature sensor, temperature sensors 18 and 20 are shown in communication with cell body 12. The method further involves monitoring temperature readings received from temperature sensors 18 and 20 and turning heating pin 16 on and off to maintain cell body 12 within a predetermined temperature range.

Referring to FIG. 3, heater pin 16 positioned within heating manifold 14 stops the fluid inside electrolysis cell 10 and reservoir 100 from freezing. Heater pin 16 preheats the fluid inside electrolysis cell 10 and reservoir 100, thus enabling faster generation of hydrogen/oxygen gases on system start up. Heater pin 16 in heating manifold 14 is, preferably, in close proximity to entry port 13, allowing heated fluid to rise through port 13 via connecting conduit 102 to heat the fluid in reservoir 100 positioned vertically above 13 port. Heater pin 16 is in direct contact with the working fluid, providing more direct and faster heating of the working fluid.

It is to be noted that there are two temperature sensors 18 and 20. Temperature sensor 18 embedded within heating manifold 14 activates heating pin 16 when the temperature within electrolysis cell 10 falls to the freezing point of the fluid. Temperature sensor 20 embedded within heating manifold 14 deactivates heating pin 16 when a desired operating temperature is achieved. Temperature sensor 20 can also be used to deactivate the electrolysis process if the temperature rises above a critical level, potentially damaging to the system.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of maintaining an electrolysis cell at operational temperature, comprising:
incorporating a heating manifold into a cell body of the electrolysis cell, the heating manifold having at least one heating element;
positioning at least one temperature sensor in communication with the cell body; and
monitoring temperature readings received from the at least one temperature sensor and turning the at least one heating element on and off to maintain the cell body within a predetermined temperature range.

2. An electrolysis cell, comprising:
a cell body;
a heating manifold incorporated into the cell body;
at least one heating element supported by the heating manifold;
at least one temperature sensor in communication with the cell body; and
a controller monitoring temperature readings received from the at least one temperature sensor and turning the at least one heating element on and off to maintain the cell body within a predetermined temperature range.
